(19) United States
(12) Patent Application Publication
(10) Pub. No.: US 2003/0161761 A1
(43) Pub. Date: Aug. 28, 2003

(54) Apparatus and method for composing high density materials onto target substrates by a rapid sequence

(76) Inventors: Roger O. Williams, Paradise Valley, AZ (US); Charles A. Reichel, Fremont, CA (US)

Correspondence Address: Richard R. Batt, Morrison & Foerster LLP, 755 Page Mill Road, Palo Alto, CA, 94304-1018, US

(21) Appl. No.: 10/087,529

(22) Filed: Feb. 28, 2002

(51) Int. Cl. B05D 1/00; G01N 1/10

(52) U.S. Cl. 422/63; 427/8; 422/100; 436/180

(57) ABSTRACT

A system for composing high-density arrays of biological and chemical materials onto target substrates by a rapid sequence. A system includes a thin liquid transfer plate having a fill side, a dispense side and a plurality of channels extending therethrough. The channels of the liquid transfer plate may be loaded with chemical and or biological materials. Once loaded, the materials are ejected from the liquid transfer plate onto a plurality of target substrates. The system further includes various arm assemblies to manipulate and position the liquid transfer plate and the target plates. Additional liquid transfer plates may be loaded and dispensed onto the plurality of target substrates. Methods for composing a high-density array are also provided.

### TECHNICAL FIELD

This is directed to systems for composing high-density arrays of biological and chemical materials onto target substrates and in particular, a non-contact system for composing high density arrays onto target substrates by a rapid sequence.

### BACKGROUND

Various techniques for making microarrays of chemical and biological materials are currently available including but not limited to 1.) ink-jet deposition, 2.) capillary deposition and 3.) photolithographic synthesis. See, for example, International Application No. PCT/US97/24098.

In ink-jet deposition, a voltage is applied across a piezoelectric material to cause a volumetric change in the fluid. The volumetric changes in the fluid cause a droplet to be formed and ejected on demand.

Capillary deposition involves the use of bundled capillary tubing to dispense small amounts of the biosite solution onto the reaction substrate. The capillary bundle allows for multiple chemically unique biosites to be created with a single “stamp” onto the reaction substrate. See also International Application Nos. PCT/US01/05695 and PCT/US01/05844.

Photolithographic microarray synthesis builds nucleic acid sequences one base at a time. A series of masks are sequentially applied to build the nucleic acid probes. An array of oligonucleotide probes (e.g., each having 12 bases) would require numerous masks and take many hours to complete the wafer. See also U.S. Pat. Nos. 5,744,305 and 5,445,934.

Still other printing systems include use of syringe needles and or pin style printing. The syringe needles or capillaries draw up fluid to be dispensed. The syringe needles dispense multiple biosites and then return to reload or collect a new probe solution. Pin style dispensing systems print one biosite at a time. The pins are dipped into a probe solution and the amount of solution on the pin is transferred to the substrate forming the biosite or array element.

U.S. Pat. No. 5,807,522 to Brown et al. describes another method for making a microarray by moving a capillary dispenser into a selected position and tapping the dispenser on a support under conditions effective to draw a defined volume of liquid onto the support. The capillary dispenser is loaded with a new solution by washing the capillary with a wash solution, removing the wash solution and dipping the capillary in a new reagent.

International Application No. PCT/US99/20692 describes another capillary printing system. In particular, a detachable ganged plurality of printing devices are disclosed where the printing devices comprise a reservoir, a capillary and a printing tip which prints an agent onto the substrate.

International Application No. PCT/US99/15044 describes another apparatus and method for printing arrays using gene pen devices. The gene pen device comprises a reservoir, a printing head connected to the reservoir, and a flow control means in the printing head such as a pin valve means or felt means.

International Application No. PCT/US99/08956 describes yet another technique for depositing high-density biological or chemical arrays onto a solid support. In this application, a plurality of open-ended channels form a matrix. The channels on the loading end have a larger diameter than the channels at the liquid delivery end. The matrix is redrawn such that at any point along the height of the capillary device, all cross sectional dimensions are uniformly reduced.

Many of the techniques, described above, require printing devices to contact the target substrate or the liquid sources. Consequently, the printing devices themselves spread contaminate. To minimize contamination in such systems additional steps are required such as washing and cleaning the printing devices between each cycle. This slows down the printing process and increases its complexity.

Still other shortcomings of the above-described systems include high cost, and bulky/cumbersome equipment. Additionally, none of the above-described techniques provide for the features of the present invention as described hereinafter.

### SUMMARY OF THE INVENTION

The present invention is a system and method for composing arrays of biological and chemical materials onto at least one target substrate.

In one variation a non-contact system for composing microarrays comprises a first arm assembly for manipulating a liquid source plate (e.g., a multiwell plate). The system also includes a liquid transfer plate having a plurality of channels extending therethrough. In one variation, the liquid transfer plate is a planar card having a fill side, dispense side and a plurality of channels extending from the fill side to the dispense side.

The system further includes a second arm assembly for manipulating the liquid transfer plate. The second arm assembly is configured to align a first channel of the liquid transfer plate with a first source well of the multiwell plate such that when a first material contained in the first source well is ejected from the first source well the first material enters the first channel. In a variation, the second arm assembly provides angular motion as well as XYZ motion.

The system further includes a non-contact liquid dispensing device (or ejector) for ejecting the first material from the first source well into the first channel. The non-contact liquid dispensing device may be an acoustic energy transmitter that focuses acoustic energy on a free surface of the material to be ejected. The energy is sufficient to eject a droplet of the source material in the well. The acoustic emitter may be positioned underneath the multiwell plate.

The system further includes a pressure source fluidly connectable with the channels. The pressure source can controllably increase pressure to one or more of the channels causing material contained in the channels to eject from the liquid transfer plate. The material is thusly deposited onto a target substrate.

In a variation of the present invention, a system comprises a dispense nest configured to receive the liquid transfer plate from the second arm assembly and hold the liquid transfer plate during dispensing. The nest may be controllably movable in the XYZ directions with a third arm assembly.

Another variation of the present invention is a system as described above and additionally comprising a fourth arm assembly for carrying and positioning the target substrate (or target tray) relative to the liquid transfer plate. The fourth arm assembly may be controllably movable in the XYZ directions.

In another variation, the target substrate is positioned above the liquid transfer plate during the dispensing. In another variation, the liquid transfer plate is positioned above the target substrate during dispensing.

In still other variations of the present invention, the system includes a multiwell plate stacker for holding a plurality of source well plates, a liquid transfer plate stacker for holding a plurality of liquid transfer plates, and or a target tray stacker for holding a plurality of target trays (each target tray holding one or more target substrates).

In another variation of the present invention, the system includes a camera for viewing dispensing. The camera may be movable in the XYZ directions. The camera's position is adjusted to view dispensing. The system may further include a computer to control movement of each of the components such as the first, second, third and fourth arm assemblies.

A variation of the present invention provides an algorithm to determine variables and parameters of the system for an application.

In another variation of the present invention, a liquid transfer plate for transferring biological and chemical materials onto a target substrate comprises a planar body having a fill side, a dispense side and a plurality of channels extending from the fill side to the dispense side. The liquid transfer plate may be a rigid substrate formed from a substance selected from the group consisting of glass, ceramic, silicon wafer, plastic, stainless steel, tungsten, beryllium, and molybdenum. The thickness of the liquid transfer plate can range from 4 mm to 2 mm and perhaps 2 mm to 0.1 mm.

In yet another variation, the channels have circular cross sections. The diameter of the channels may be constant or vary. For example, the body may be tapered or untapered. In one variation, the diameter of the channels decreases from said fill side to said dispense/ejection side. Also, the diameter of the channels may range from 2 mm to 0.5 mm and perhaps 1 mm to 0.1 mm.

In another variation of the present invention, a non-contact method for composing a microarray comprises loading a first liquid transfer plate with primary materials to be printed and dispensing at least a portion of said primary materials onto at least one target substrate.

In a variation, the step of loading comprises transferring a first liquid from a first source well of a multiwell plate to a first channel of a plurality of channels of the first liquid transfer plate. The loading step further comprises transferring a second liquid from a second source well of the multiwell plate to a second channel of the first liquid transfer plate. The second liquid can be different than the first liquid. In this manner, the present invention provides for selectively loading numerous materials from any source well into any desired channel of the liquid transfer plate.

In a variation, the step of dispensing includes sequentially dispensing a portion of the first and second liquids from the first and second channels respectively onto each target substrate of a first set of target substrates. The first liquid may be dispensed onto, for example, 10 to 500 target substrates. In this manner, arrays of elements may sequentially formed on multiple target substrates.

In another variation, the method comprises loading a second liquid transfer plate with ancillary materials. A variation provides for loading the second liquid transfer plate while dispensing the primary materials from the first liquid transfer plate. Still another variation includes dispensing the ancillary materials onto a second set of target substrates in a sequence (one target substrate at a time).

### BRIEF DESCRIPTION OF THE DRAWINGS

FIG. 1 is a perspective view of a system for composing high-density arrays of biological materials in accordance with the present invention.

FIG. 2 is a partial perspective view of the system shown in FIG. 1.

FIG. 3 is a bottom perspective of view of a liquid transfer plate in accordance with the present invention.

FIG. 4A is a top view of the liquid transfer plate shown in FIG. 3.

FIG. 4B is a cross section view taken along the line 4B-4B of the liquid transfer plate shown in FIG. 4A.

FIG. 5 depicts a channel of a liquid transfer plate being loaded with a material from a selected source well in accordance with one variation of the present invention.

FIG. 6 is an illustration of an acoustic liquid dispenser system for ejecting droplets of materials from a liquid source plate (e.g., a multiwell plate).

FIG. 7 is a partial cross sectional view showing material being ejected from a liquid transfer plate onto a target substrate in accordance with the present invention.

FIG. 8 is an illustration of materials being dispensed onto a single target substrate in accordance with the present invention.

FIG. 9A is a chart illustrating the steps of an algorithm in accordance with present invention.

FIG. 9B is a chart showing tabulated data in carrying out the algorithm of the present invention.

FIG. 9C is another chart illustrating steps of an algorithm in accordance with the present invention.

FIG. 10A is a partial perspective view of another system in accordance with the present invention.

FIG. 10B depicts dispensing materials from a liquid transfer plate onto a target substrate in accordance with another variation of the present invention. In this variation, the target substrate is located below the liquid transfer plate.

### DETAILED DESCRIPTION

The present invention is a system and method for composing high-density arrays of biological materials onto target substrates. The present invention generally comprises (1) loading a liquid transfer plate with materials to be printed and (2) dispensing the materials from the liquid transfer plate onto at least one target substrate. The present invention further includes a system and algorithm for optimizing printing throughput such that different materials may be printed onto a plurality of target substrates in a rapid sequence. The following disclosure provides exemplary embodiments for carrying out the present invention. Other features and advantages of the invention will be apparent from the following disclosure, accompanying drawings and the appended claims.

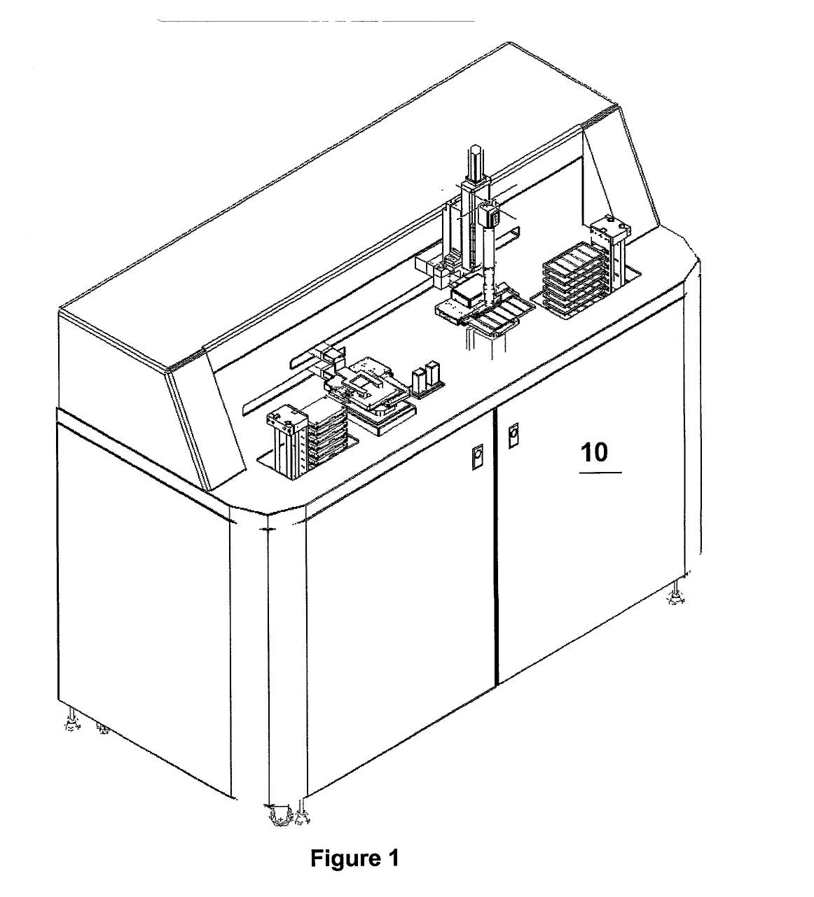

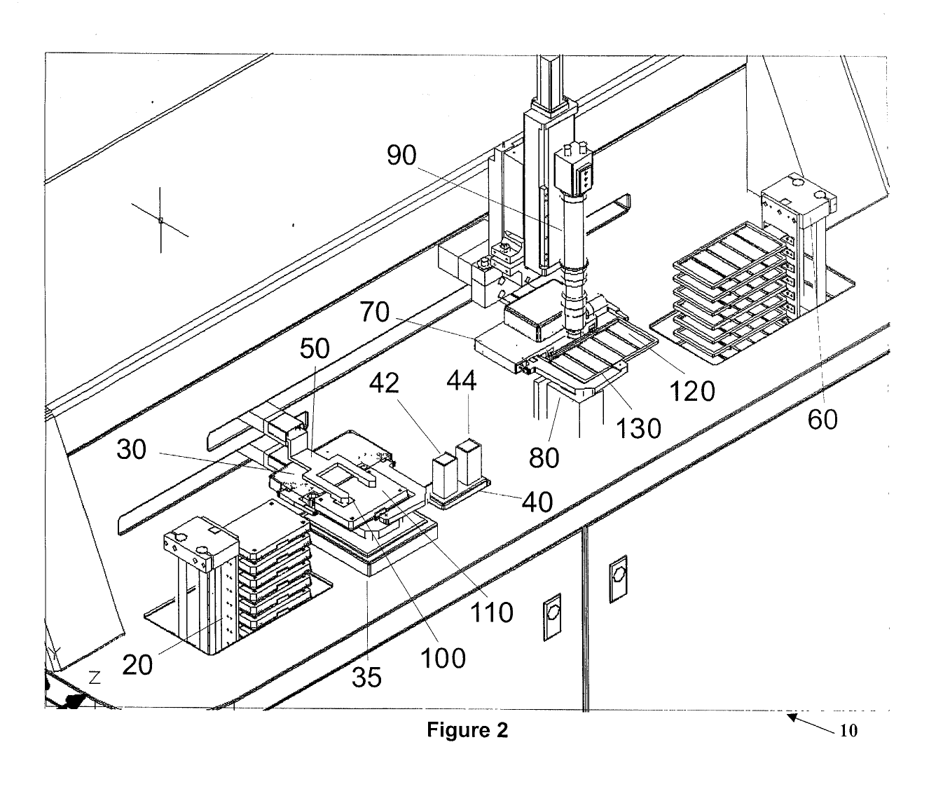

FIGS. 1-2 depict a system (10) in accordance with the present invention. The system (10) includes a number of components and assemblies, described below, which cooperate together to print materials onto a target substrate.

Referring to FIG. 2, a first arm assembly (30) and a second arm assembly (50) respectively hold a liquid source plate (110) and a liquid transfer plate (100) over an acoustic liquid transfer device (35). The acoustic liquid transfer device directs acoustic energy at a material in a selected well of the liquid source plate (110). This causes the material to eject upwards, out of the well, and into a channel of a liquid transfer plate (100). Materials are thus ejected into selected channels of the liquid transfer plate (100) without contacting the materials. Also, the first and second arm assemblies shown in this figure are designed to move in the X and Y directions. Consequently, each channel of the liquid transfer device may be filled with the material from any well of the multiwell plate (110).

After the liquid transfer plate (100) is loaded with various materials to be printed, the liquid transfer plate is positioned in dispense nest (80). In this variation, dispense nest (80) is moveable in the XYZ directions and provides fluid pressure to eject the materials from the liquid transfer plate. In one variation, described below, dispense nest (80) provides a pulse of gas to the channels causing ejection of the materials from the channels.

FIG. 2 also shows a third arm assembly (70) holding a tray (130). In particular, tray (130) is shown holding five target substrates or chips (120). The third arm assembly manipulates the tray (130) such that the chips (120) are positioned over the liquid transfer plate and in position to receive ejected droplets. The third arm assembly (70) and the nest (80) preferably move in the XYZ directions. Thus, materials can be deposited at various locations on the chips (120).

In one variation, as will be described in more detail below, a pattern of array elements (spots) is ejected from the liquid transfer plate onto one target substrate. Then, the liquid transfer plate is stepped to a second target chip and the pattern is printed on the second chip. This process is repeated until each chip (120) is printed with the pattern from the liquid transfer plate. Once all the materials are ejected from the liquid transfer plate (or all the target chips are printed), the first liquid transfer plate is replaced with a second liquid transfer plate and the process is repeated so that each target chip is printed with a second pattern. The first and second patterns may be printed to overlap or not overlap. The process is repeated until from 2 to upwards of 1,000,000 different materials are printed on each chip (120). The process can be repeated until an infinite amount different materials are printed on each chip (120).

FIGS. 1 and 2 also show a camera assembly (90) positioned above the target chip (120) and the dispense nest (80). The camera views printing and provides feedback to a computer (not shown). The computer preferably can adjust various parameters of droplet ejection including, for example, size, location, speed, and other parameters useful in microarray printing.

All the above-described components may be set in a support structure or frame. The frame may be made of, for example, steel. Various sections of the system may be enclosed with solid plastic, sheet metal and or other materials to protect the system's components as well as prevent injury to people using the system. Additionally, the whole assembly may be placed on castor wheels and adjustable feet.

Liquid Transfer Plate

As stated above, the present invention provides for loading materials into a liquid transfer plate and dispensing materials from the liquid transfer plate onto a target substrate.

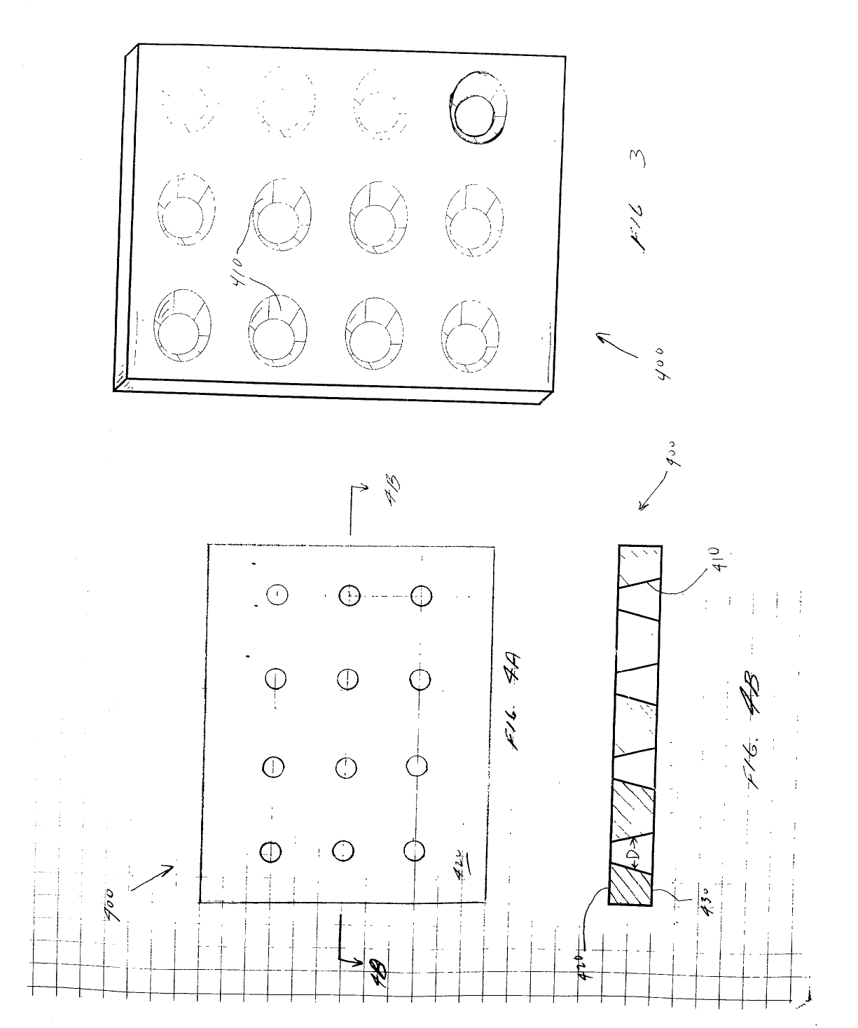

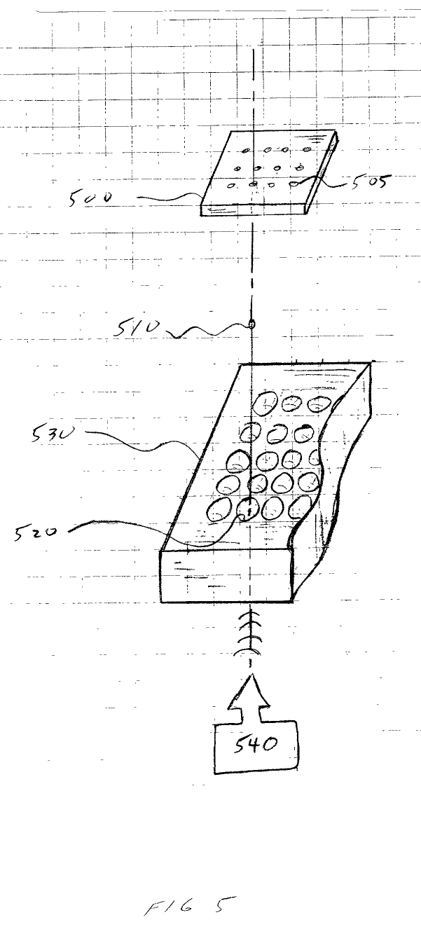

Referring to FIGS. 3-4, an exemplary liquid transfer plate (400) includes a plurality of channels (410). In FIGS. 3-4, twelve channels are shown in a rectangular array. However, the array may take a non-rectangular shape. For example, the array of channels may take a circular, oval or other shape. Also, the liquid transfer plate may have more or less than twelve channels. The liquid transfer plate may have between 4 and 5280 channels and perhaps 144 to 6144 channels. The density of the channels per sq. cm. can be in the range of 40 to 440 and perhaps 400 to 1536.

In the variation shown in FIGS. 3-4, the channels (410) have a circular cross section. Additionally, the channels (410) are tapered and their cross sections vary from one end of the channel to the other end. In the configuration shown in FIGS. 3-4, the channel diameter is smallest on the dispense or liquid ejection side (420) of the liquid transfer plate. The diameter is largest on the fill side (430) of the plate. The diameter of the channels may range from 2 mm to 0.5 mm and perhaps 1 mm to 0.1 mm.

The liquid transfer plate (400) shown in these figures is a thin planar card. However, the invention is not so limited and the shape of the liquid transfer plate (400) may vary. For example, the liquid transfer plate may be circular, donut, square, rectangular, triangular or otherwise shaped. The body of the liquid transfer plate may be custom designed for mating or fitting within chambers, wells, and other structures which may be used in combination with the liquid transfer plate.

Dimensions for the liquid transfer device may also vary. For example, the liquid transfer plate or card may have a length in the range of 10 mm to 35 mm and perhaps 20 mm to 70 mm. Its width may be from 1 mm to 24 mm and its thickness may be from 1 mm to 4 mm and perhaps 0.1 to 2 mm.

The liquid transfer plate (400) is preferably rigid. Exemplary materials for the liquid transfer plate include glass, ceramic, silicon wafer, plastic, stainless and other steels, tungsten, beryllium, and molybdenum.

The liquid transfer plate may be fabricated using injection molding techniques, conventional machining and micromachining techniques such as photolithography and chemical etching techniques. Vapor deposition and other semiconductor processes may be used to fabricate the liquid transfer plates. Also, casting is contemplated to form the liquid transfer plates such as, for example, casting ceramic. Still other techniques may be used to make the liquid transfer plate as is known to those skilled in the art.

A plurality of liquid transfer plates may be conveniently stacked as shown in FIGS. 1 and 2. In particular, a liquid transfer plate stacker (40) provides a stack of “un-used” identically shaped liquid transfer plates (42). “Used” liquid transfer plates may be discarded in a return stack (44).

The liquid transfer plate stacker (40) aligns a plurality of liquid transfer plates (42, 44) such that each liquid transfer plate may be picked up and returned by second arm assembly (50). Once one liquid transfer plate is picked up, the stack of un-used liquid transfer plates are moved upwards to position the next liquid transfer plate into a first position to be picked up by second arm assembly (50). In this manner, a plurality of liquid transfer plates may be conveniently held.

In one variation, 10 to 100 liquid transfer plates are stacked and perhaps, 20 to 50. However, different numbers of liquid transfer plates may be held depending on the application, discussed further below.

Liquid Source Plate

As indicated above, biological or chemical materials are loaded into the liquid transfer plate from a liquid source plate (e.g., a multiwell plate). Particularly, the materials are loaded without being contacted by an additional liquid transfer device such as a capillary or syringe. This non-contact attribute arises because the liquid transfer plate is divorced from the liquid source plate.

Examples of liquid source plates are conventional multiwell plates such as Greiner #782097 1536-well, Polystyrene, Clear®, black, high binding multiwell plate manufactured by Greiner in Longwood, Fla. The number of wells in the well plate can vary from, for example, 96 wells to upwards of 1000 wells. Additionally, other source liquid containment structures may be used and the invention is not to be limited to a particular type of liquid source plate.

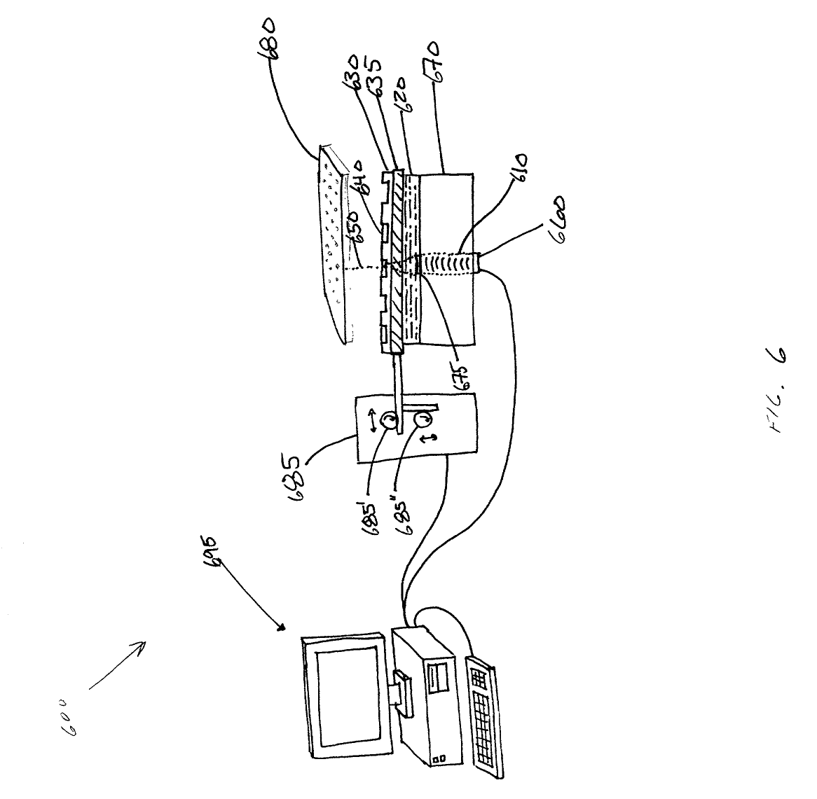

FIG. 5 illustrates loading a liquid transfer plate (500). The liquid transfer plate (500) shown in FIG. 5 includes a plurality of channels (505) which are selectively loaded as described hereinafter. For simplicity, the supporting assemblies such as the first and second arm assemblies are not shown in this figure.

Referring to FIG. 5, one or more droplets (510) of materials are ejected from a selected well (520) of a source well plate (530). Acoustic energy (540) from an acoustic energy delivering device, discussed below, causes the droplets (510) to eject. In this manner, a controlled volume of material from a selected source well (520) may be delivered to a particular channel (505) of the liquid transfer plate (500). This provides for selectively and controllably loading each channel of the liquid transfer plate with materials from a multiwell plate (530).

Additionally, multiple liquid source plates may be stacked in a source plate stacker (20) shown in FIG. 2. Like the liquid transfer plate stacker (40) described above, the source plate stacker (20) holds and positions the liquid source well plates, providing convenient pick-up and return for first arm assembly (30).

Acoustic Liquid Ejector

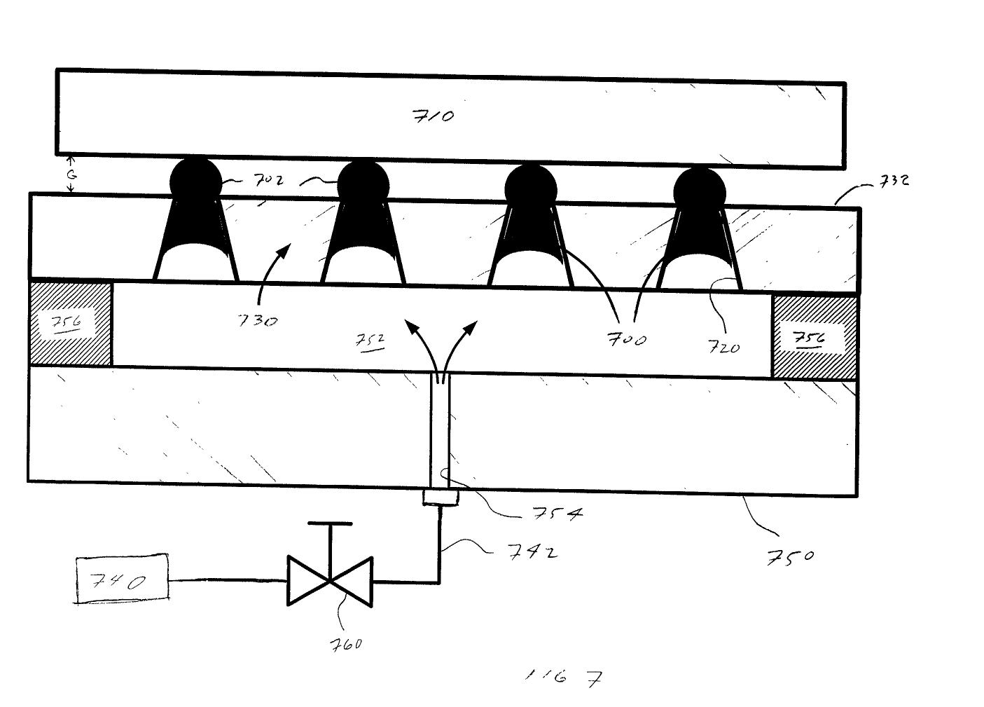

Biological materials are transferred from the multiwell plate to a liquid transfer plate using a liquid transfer ejector. An exemplary liquid transfer device or ejector is shown in FIG. 6 and is described in U.S. patent application Ser. No. 09/735,709 filed Dec. 12, 2000 and entitled “Acoustically Mediated Fluid Transfer Methods And Uses Thereof.”

The exemplary liquid ejecting system (600) shown in FIG. 6 includes at least one acoustic wave emitter (660) in electrical communication with a computer (695). The acoustic emitter (660) may be, for example, a piezoelectric element.

During operation the acoustic emitter (660) generates an acoustic wave or beam (610) that can be propagated through an optional wave channel (670). The acoustic wave can be focused by lens (675) prior to propagating through coupling fluid (620) to optimize the energy of the acoustic wave or beam (610) upon the liquid/air interface (free surface) of source fluid (640). The source fluid (640) is the biological or chemical materials to be loaded into a liquid transfer plate (680) in accordance with the present invention.

The acoustic wave (610) is thus propagated through a coupling medium (620) after which the wave is transmitted through source fluid containment structure (630) (e.g., a multiwell plate) where the wave comes to focus at or near the surface of a pool of source fluid (640) thereby causing the liquid to urge upwards so as to eject a droplet (650) from the source well to the liquid transfer plate (680). The acoustic liquid transfer device (600) thusly ejects droplets of materials to the liquid transfer plate (680) without contacting the materials to be transferred.

It is to be understood, however, that the present invention may employ other mechanisms or devices for transferring materials from a liquid source plate (e.g., a multiwell plate) to the liquid transfer plate and is not to be limited to the examples provided above except as recited in the appended claims.

Dispense Nest

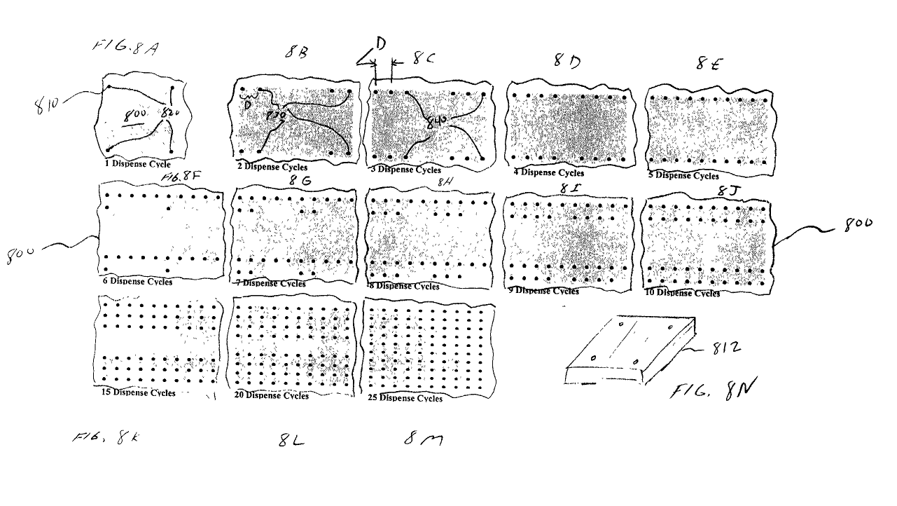

FIG. 7 is a cross sectional illustration showing at least a portion of materials (700) being deposited onto a target substrate (710) in accordance with one variation of the present invention. In particular, droplets (702) are ejected from channels (720) of liquid transfer plate (730) onto the target substrate (710).

In this variation, fluid pressure causes droplets (702) to form and eject from a dispense side (732) of the liquid transfer plate (730). A pressurized gas source (740) is fluidly connected with one or more of the channels (720) via a line (742) and dispense nest (750). The pressurized gas may be any one of a number of gases including, for example, air or nitrogen. The pressurized gas is controlled with a valve (760) which may be actuated by a controller not shown.

Using a computer, discussed further below, pressure is applied continuously or as a short pulse. The pressure applied ranges from 0.1 psi to 40 psi and perhaps 0.001 psi to 20 psi. When applied as a pulse, the time for each pulse ranges from 0.1 ms to 1,000 ms and perhaps 0.01 ms to 4,000 ms.

Dispense nest (750) includes a cavity (752) and passageway (754) through which pressured gas may flow. An elastomeric gasket (756) or o-ring may be provided to prevent pressurized gas from leaking out unintended spaces. In the variation shown in FIG. 7 cavity (752) is substantially larger than the channels (720). The cavity in this variation is shown fluidly connecting with each and every channel (720). Consequently, a pulse of pressurized air will displace at least a portion of material from each and every channel causing droplets to eject from each and every channel onto the target substrate (710).

In an alternative variation, multiple pressure lines may be fluidly connected with selected channels to dispense droplets from selected channels.

The dispense nest may be movable in XYZ directions. The nest may thus print a pattern, and step to the next target substrate, and print again. In this manner, a plurality of target substrates or chips are printed with the pattern defined by the liquid transfer plate (730).

Notably, materials are deposited onto the target substrate without contact. The system separates the liquid transfer plate (730) and the target substrate (710) with a gap (G). The gap (G) may be controlled to optimize droplet ejection and ranges from 1 times the diameter of the dispensed droplet to 10 times the diameter of the dispensed droplet and perhaps, 0.1 times the diameter of the dispensed droplet to 20 times the diameter of the dispensed droplet. Dispensed droplet sizes range from 1 um to 500 um in diameter. To reiterate, the presence of gap (G) allows the liquid transfer plate to be divorced from the target substrates and thus, provides “true” non-contact microarray printing.

The target substrates or chips may be variously sized and shaped. The chips, for example, may be rectangular, circular or otherwise shaped. Also, the surfaces of the chips may vary. The chips may be flat or have recesses. In one variation, the target structures are conventional multiwell or assay plates and materials are dispensed from the liquid transfer plate into the wells. In another variation the target structures or substrates are non-conventional or custom multiwell plates. In yet another variation, the target substrates are simple flat rectangular slides. Materials for the target chips and substrates include glass, silicon wafer, plastic, noble metals and other substances, which can form a support or substrate for arrays of biological materials.

Referring again to FIG. 2, five chips are shown fixed on a tray (130). The tray is held by third arm assembly (70). While this variation shows a tray sized to hold five chips, the tray may be larger or smaller and hold more or less chips respectively. Trays may hold 1 to upwards of 100 target chips. Also, a tray stacker assembly (60) may be provided to hold and provide multiple trays of target substrates to the third arm assembly (70). After all the chips on a tray are printed with materials, the tray is returned to the tray stacker and a second tray having additional target substrates is gripped and manipulated to the dispense nest (80). In a particular variation, at least one of the dispense nest and the tray are moveably relative to one another so that the system may deposit patterns of materials from liquid transfer plates variably, rapidly and precisely.

Camera Assembly

As shown in FIG. 2, a camera assembly (90) is provided to observe and measure droplet ejection onto the target substrates. The camera assembly (90) is positioned such that dispensing events are continuously observed. Typically the camera assembly (90) is controllably moved in the XYZ directions.

Additionally, the camera can provide visual feedback to a computer (not shown) such that printing may be adjusted. For example, the camera may observe “mis-aligned” print patterns. Determining whether a print pattern is mis-aligned may be carried out by digitizing an image of the printed array elements (or droplets) and measuring the droplet's center to a reference point. The camera may also be useful in providing feedback about droplet size as the dispensed droplet area may be measured from a digitized image of the dispensed droplet. Variables can thus be adjusted in real time to optimize printing onto a target substrate. Examples of variables include but are not limited to: pressure, XYZ position, time. Still other methods for measuring and monitoring printing may be employed as is known to those of skill in the art.

Example of Composing Array on Target Substrate

FIGS. 8A-8M illustrate one example of composing an array of materials on a single target substrate (800) in accordance with the present invention.

FIG. 8A shows a first step of a sequence of steps. In particular, FIG. 8A shows array elements (e.g., spots) (810) of materials on the target substrate (800). The spots (810) are formed by ejecting at least a portion of materials from channels of a first liquid transfer plate such as liquid transfer plate (812) of FIG. 8N. The first liquid transfer plate may be configured as described above and each of the materials ejected may be different. Consequently, each spot (810) deposited on the target substrate (800) may be different.

After the target plate (800) is printed with a first set of spots (820), the first liquid transfer plate is replaced with a second liquid transfer plate. The second liquid transfer plate may have four channels each containing materials to be printed.

FIG. 8B shows a second printing step wherein materials from the second liquid transfer plate are printed onto the target substrate (800) forming a second set of spots (830) at locations adjacent to the first set of spots (820). The second set of spots (830) are separated from the first set of spots by a distance D. Accordingly, an array comprising eight 8 spots of materials is formed on the target substrate (800).

The above-described process is repeated. In the example illustrated by FIGS. 8A-8M, 25 different liquid transfer plates are used (one at a time) to dispense materials in a rapid sequence onto target plate (800). There are 25 dispense events (each event consisting of the ejection of 4 droplets), forming a complete array on the target substrate (800) as shown in FIG. 8M. While the array shown in FIG. 8M consists of 100 by 100 spots of materials, arrays may be formed with more or less spots.

It is also to be understood that while FIGS. 8A-8M show composing an array of spots on only one target plate (800), the invention is not so limited. The patterns of spots (820, 830, 840, etc.) depicted in FIGS. 8A-8M, for example, may be sequentially printed onto a plurality of target substrates (not shown). To reiterate, a first set of array elements (or spots) from a first liquid transfer plate is printed onto a first target substrate. The first liquid transfer plate is stepped to an ancillary target substrate and a set of spots is printed onto the ancillary target substrate. The liquid transfer plate is sequentially stepped to additional target substrates and additional sets of spots are printed thereon. Each set of spots during this first cycle of printing is identical for each target substrate. After all the target substrates are printed with the first set of spots, the first liquid transfer plate is replaced with a second liquid transfer plate to begin a second cycle of printing. During this second cycle, all target substrates receive a second set of spots. Additional printing cycles provide for printing further sets of spots on target substrates until a complete array is composed. This results in a plurality of target substrates being printed with a complete array of spots.

The present invention thus provides for printing microarrays onto target substrates in a rapid sequence. The size and location of the individual spots can be varied by controlling various parameters such as, for example, 1.) relative positioning of the liquid transfer plate with respect to the target substrates and 2.) the number of channels present in the liquid transfer plate.

Also, the liquid transfer plates may be loaded in parallel with dispensing. That is to say, while one liquid transfer plate is being loaded another liquid transfer plate is being dispensed. Parallel operations minimize the time that liquid sits idle in the liquid transfer plate. It is undesirable for the liquids to sit in the open channels because the liquids can evaporate. Accordingly, the time that the liquids sit should be minimized. Preferably, as soon as the liquid transfer plate is loaded, the liquid transfer plate is transported to the dispense nest for printing spots onto the target substrates. There should be little or no lagging. Given all the variables in the system of the present invention (e.g., number of plates, number of target substrates, number of channels, number of desired spots, time, etc.) one embodiment of the present invention incorporates an algorithm, discussed below.

Optimization Algorithm

An exemplary algorithm for use with the present invention is hereinafter described. However, this particular algorithm is not intended to limit the invention except as provided by the appended claims. Indeed, other algorithms may be used in conjunction with the present invention where elements and steps are not mutually exclusive.

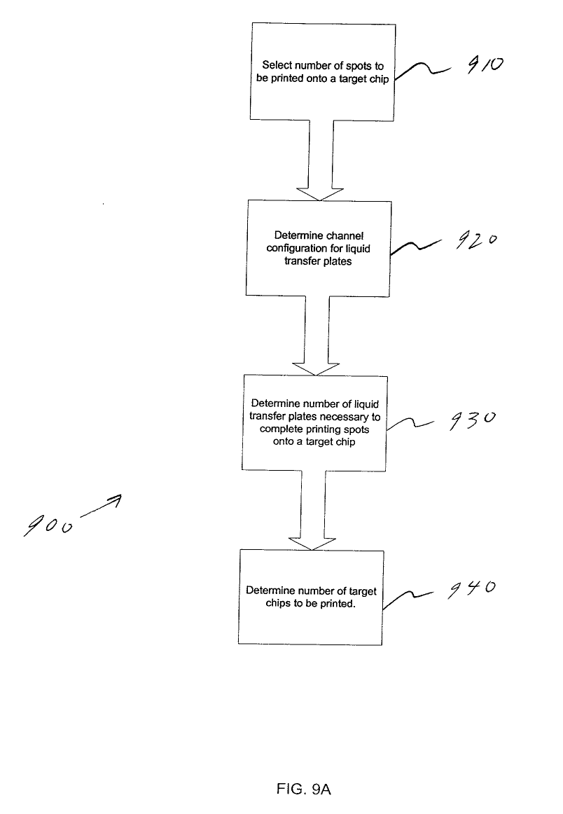

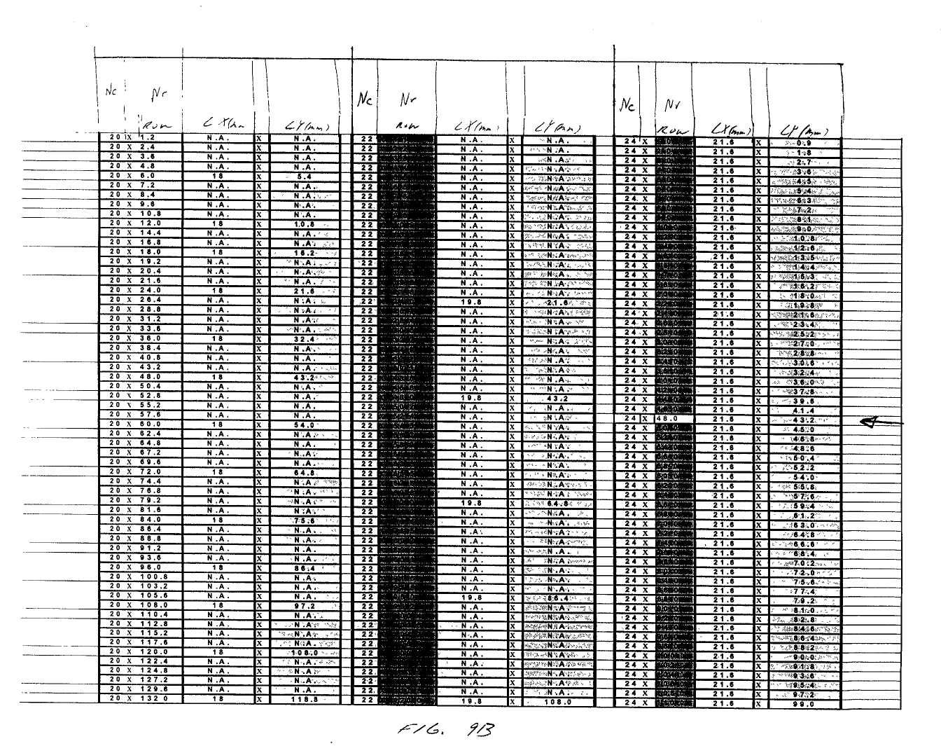

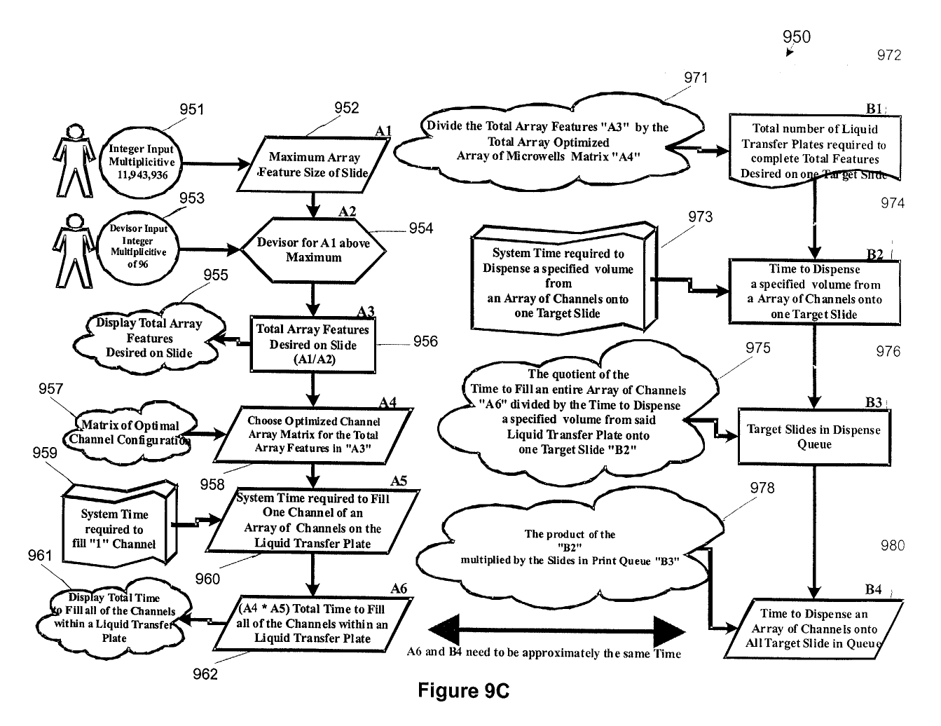

FIG. 9A is a flow chart illustrating various steps of one algorithm in accordance with the present invention. This algorithm minimizes “down time” between the loading and dispensing steps. In particular, the algorithm minimizes the difference between the time to dispense materials from the channels of a first liquid transfer plate (T_{dispense}) and the time to load the channels of a second liquid transfer plate (T_{load}). Thus, at the instant loading is complete, the second liquid transfer plate (now loaded with materials) may be positioned in the dispense nest to commence dispensing onto target chips. Ideally, but not necessarily, there is no down time between loading and dispensing.

Referring to FIG. 9A, various steps of an algorithm (900) are shown for minimizing dead time between the loading and dispensing steps. The algorithm illustrated in this chart comprises generally four steps, each of which can have one or more sub-steps. The steps of this particular algorithm (900) include: selecting a number of spots to be printed onto a target chip (910); determining a channel configuration for liquid transfer plates (920); determining a number of liquid transfer plates necessary to complete printing spots onto a target chip (930); and determining a number of target chips to be printed (940). Each of these steps are described below.

As stated above, a first step (910) includes selecting a number of spots or array elements to be printed onto a single target substrate or chip. The total number of array elements can be a multiple of 96 (e.g., 62,208 spots) and upwards of 11 million. Multiples of 96 are convenient since most multiwell plates contain a number of wells, which is also a multiple of 96. (For example, forty-one 1536-multiwell plates can provide for printing 62,208 different array elements.) Accordingly, a desired number of spots are selected.

Step (920) determines an optimal channel configuration in the liquid transfer plates. Exemplary channel configurations include 24 columns by 48 rows (hereinafter “24 by 48”), 24 by 42, etc. A particular channel configuration is based on a number of variables including, for example, the size of the target chips, the spacing between channels (P_{channel}), and the spacing between the spots (Pₛₚₒₜ).

Various iterative techniques can be used to solve for the channel configuration. A particular technique includes varying the number of rows and columns of channels, and calculating the lengths of space occupied in the X and Y directions for each combination. The lengths in the X and Y directions (LX and LY respectively) may be calculated as follows:

$$\begin{matrix}LX = [ ( Nc - 1 ) \times Pchannel ] + [ Pspot \times ( \frac{Pchannel}{Pspot} - 1 ) ] \\ and \\ LY = [ ( Nr - 1 ) \times Pchannel ] + [ Pspot \times ( \frac{Pchannel}{Pspot} - 1 ) ]\end{matrix}$$

where Nc=number of columns; Nr=number of rows; Pchannel=the distance between adjacent channels such as, for example, 0.9 mm; and Pspot=the distance between adjacent spots such as, for example, 0.1 mm. In this example, the distance between the features is identical in the X and Y directions. However, the X and Y distances between the features can be different.

Using the above equations to calculate LX and LY, a table as shown in FIG. 9B may be generated for each row/column configuration. In FIG. 9B, Nc (the number of columns) is set at 20 and LX and LY are calculated for each row (Nr) ranging from 1.2 to 132.0. Nc is then incremented by 2 and LX and LY are again calculated for each row. Nc is yet again incremented by 2 and LX and LY are again calculated for each row. This process may be repeated for as many column/row combinations as desired.

Once LX and LY are calculated as shown in FIG. 9B, a row/column configuration may be selected. One method for selecting a row/column combination is to compare the lengths (LX by LY) to a desired target chip size. For example, with reference to FIG. 9B, the 24 by 48 column/row channel configuration provides a LX and LY of 21.6 mm and 43.2 mm respectively. These lengths are suitable for a target chip having dimensions of, for example, 24 mm by 45 mm since all the spots will compactly fit on the chip. It is generally desirable to minimize dead space on the target chip. Thus, in this variation of the present invention, we select a combination of rows and columns that closely matches the target chip dimensions. In this manner, the number of rows and columns of channels for the liquid transfer plates can be determined.

Once the channel configuration is determined, the time to fill a single channel (t_{load}) can be determined. The system requires a certain amount of time to fill a single channel. This time may be measured. In one example, the time to fill a single channel was measured at 0.09 seconds. Given the time to fill a single channel (t_{load}), and the total number of channels from step (920), the time to fill all the channels (T_{load}) for each liquid transfer plate may be determined. For example, a 24 by 48 liquid transfer plate can be filled in 103.68 seconds if 0.09 seconds is required to fill each channel.

Step (930) determines the number of liquid transfer plates necessary to complete printing onto a single target chip. This number can be determined by dividing the total number of spots from step (910) by the number of channels to be provided in a liquid transfer plate from step (920). The number of channels for each liquid transfer plate is equal to the product of Nr and Nc. For example, if 62,208 spots are desired on a single target chip, 62,208 is divided by 1,152 (24×48) channels and it follows that 54 (62,208/1,152) liquid transfer plates are needed to complete printing this array onto a single target chip.

Step (940) determines the total number of target chips (N_{chips}) to be printed such that the difference between T_{load} and T_{dispense} is minimized. This is accomplished by dividing T_{load} by the time to dispense material from a liquid transfer plate onto one target chip (t_{dispense}). This time (t_{dispense}) may be provided from a database or it may be measured for each liquid transfer plate. For example, we have found that this time may equal 2.0 seconds in certain dispensing systems. Thus, by dividing T_{load} by the time to dispense material from a liquid transfer plate onto one target chip (t_{dispense}) the total number of target chips N_{chips} may be determined.

Consider a 24 by 48 channel liquid transfer plate where T_{load}=103.68 seconds and tdispense=2.0 seconds. It follows from step (940), above, that N_{chips}=T_{load}/t_{dispense}=51.8. Accordingly, about 52 target chips are necessary to make T_{load}≈T_{dispense}. In a system as described above, for example, a target tray may be provided which holds 5 target chips at a time. Accordingly, 10 target trays would hold an additional 50 chips. Accordingly, 10 target trays may be queued in a stacker assembly in order to minimize the difference between T_{load} and T_{dispense}. Note that this calculation inherently minimizes the difference between T_{load} and T_{dispense} because more or less chips are queued in order for T_{load} to equal T_{dispense}.

The above described algorithm thusly minimizes the difference (dT) between T_{load} and T_{dispense}. Exemplary ranges for “dT” include 0 to 100 seconds, 0 to 10 seconds and perhaps less than 1 second.

Accordingly, the present invention provides an algorithm that determines, amongst other things, a channel configuration for a liquid transfer plate and an optimum number of target chips to be printed upon such that there is no lagging between the loading and dispensing steps.

FIG. 9C also illustrates various steps of an algorithm (950) in accordance with the present invention. The algorithm (950) is intended to minimize the time difference between loading the channels of a liquid transfer plate and dispensing materials from the liquid transfer plate onto all the target slides stored in a queue. That is, the total time to load a liquid transfer plate calculated from step (962) should equal the dispense time calculated from step (980).

To carry out the algorithm of FIG. 9C, an integer input multiplicative of 11,943,936 is provided as shown in step (951) to obtain a maximum number of features to be deposited on a target slide. A devisor input integer multiplicative of 96 is also input as shown in steps (953, 954). The total number of array features to be deposited on a slide is determined by dividing the maximum number of features by the devisor as shown in step (956). This value may also be displayed by the computer.

Step (958) determines the optimized channel array matrix or channel configuration for the liquid transfer plates as described above.

Step (960) determines the time required to fill one channel of the liquid transfer plate. This system information may be known from previous testing, calculations, or a database values. Step (962) determines the total time to fill all the channels of the liquid transfer plate and is determined by multiplying the total number of channels of a liquid transfer plate (958) by the time required to fill one channel as found in step (960).

The total number of liquid transfer plates needed to complete printing the total number of features onto a target slide is determined in step (972). In particular, as indicated by reference numeral (972), the total array features determined in step (956) is divided by the total array channels on each liquid transfer plate as determined by step (958).

Step (974) provides for the time to dispense a specified volume of material from the liquid transfer plate onto one target slide. This may be provided by the system based on past data, etc.

Step (976) determines the number of target slides in queue. That is, this step determines the number of additional target slides to be held in queue. As indicated by reference numeral (975), this step is determined by dividing the total time to fill all the channels of a liquid transfer plate (see step (962)) by the time to dispense a specified volume from a channel array of one liquid transfer plate. Accordingly, step (976) provides the number of target slides in queue.

The time to dispense an array of channels onto all the target slides (see step (980)) is determined by multiplying the time to dispense a specified volume from an array of channels onto one target slide (step (974)) by the number of slides in queue as determined by step (976).

Accordingly, the time to dispense an array of channels of a liquid transfer plate onto all the target slides (step (980)) will equal the total time to fill all the channels of a liquid transfer plate as determined from step (962). Accordingly, there will be no lagging between the loading and dispensing steps.

Additional Embodiments

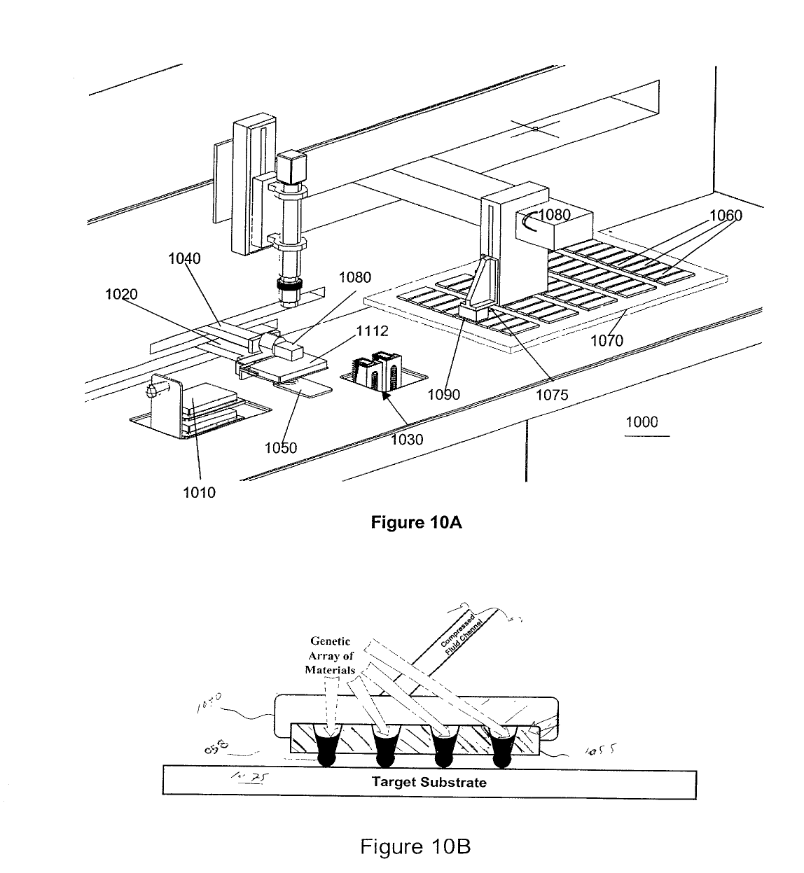

FIGS. 10A-10B show another variation of the present invention. Referring first to FIG. 10A a system (1000) includes a plurality of liquid source plates (1010), a first arm assembly (1020) for moving the source plates, a plurality of liquid transfer plates (1030), a second arm assembly (1040) for moving the liquid transfer plates, a liquid transfer device/ejector (1050) for ejecting materials from a source well of the liquid source plate into a channel of the liquid transfer plate, a plurality of target chips (1060) on a target tray (1070), and a third arm assembly (1080) for moving a liquid transfer plate into position to deposit a set of spots onto a target substrate. The third arm assembly (1080) steps across each of the target chips (1060) before replacing the liquid transfer plate with a new liquid transfer plate.

A difference between the variation shown in FIGS. 10A-10B and that described above is that in dispensing materials onto a target chip (1075), the liquid transfer plate (1055) (see FIG. 10B) is positioned above the target chip (1075) and droplets (1058) are ejected downwards onto the target chip. In contrast, droplets (702) are ejected upwards in the system shown in FIG. 7.

Additionally, the second arm assembly (1040) shown in FIG. 10A includes angular rotating member (1080). The rotating member (1080) of the second arm assembly picks up a liquid transfer plate from the stack (1030). The liquid transfer plate is moved into position over a source well plate (1112) and each of the channels are loaded with materials from the source wells.

After the liquid transfer plate is loaded, the second arm assembly rotates the liquid transfer plate upside down and sets it in the dispense nest (1090) such that the dispense side of the liquid transfer plate correctly faces the surface of the target chips.

Once the liquid transfer plate is positioned in the dispense nest (1090), the second arm assembly returns to the stack (1030) and picks up a second liquid transfer plate to be loaded. Meanwhile, the third arm assembly (1080) steps the first liquid transfer plate across each of the target chips, sequentially dispensing a set of spots onto each target chip. Cycles are performed as necessary until an array is completed on each target chip (1060).

It is to be understood that the present invention may include more or less arm assemblies than described above. For example, in one variation, only two arm assemblies are necessary: a first arm assembly to manipulate the source well plates and a second arm assembly to manipulate the liquid target plates. However, additional arm assemblies can provide more flexibility and speed.

It is also to be understood that different components can be stationary or moving to carry out the present invention. For example, to print materials onto target chips held in a target tray 1) the dispense nest may be moved; 2) the target tray may be moved; or 3) both components may be moved to provide the relative motion required to print spots on each of the target chips in accordance with the present invention. Thus, unless otherwise required, the present invention can have various components moving or stationary to load and dispense the materials onto the target chips.

In view of the foregoing, it should be apparent that the system of the present invention provides for increased speed and flexibility in composing high-density arrays of biological materials. The present invention also provides for minimum contamination due to its non-contact nature.

Also, the present invention has various applications. For example, the present invention may be used to compose microarrays for use in drug discovery/screening and DNA sequencing. However, the present invention may be used to carry out other applications which can benefit from it.

It is contemplated that the liquid transfer plates of the present invention may cleaned and reused after a use. Also, the liquid transfer plates may be discarded or disposed of after a use. In one variation, a kit of disposable liquid transfer plates. The disposable liquid transfer plates may be fabricated for any target structure or array pattern to be printed.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

All publications, patent applications, patents, and other references mentioned above and hereinafter are incorporated by reference in their entirety. To the extent there is a conflict in a meaning of a term, or otherwise, the present application will control.

1. A non-contact system for composing microarrays comprising:
a first arm assembly for manipulating a liquid source plate, said liquid source plate having a plurality of source wells each adapted to hold a material for forming said microarrays;
a liquid transfer plate having a fill side and a dispense side and a plurality of channels extending therethrough;
a second arm assembly for manipulating the liquid transfer plate, said second arm assembly configured to align a first channel of said plurality of channels with a first source well of said plurality of source wells such that when a first material contained in said first source well is ejected from said first source well said first material enters said first channel;
a non-contact liquid dispensing device for ejecting said first material from said first source well into said first channel; and
a pressure source fluidly connectable with said fill side of said liquid transfer plate wherein said pressure source is configured to controllably increase pressure to one or more of said channels thereby ejecting at least a portion of said materials from said liquid transfer plate onto a target substrate.

2. The system of claim 1 further comprising a dispense nest configured to receive said liquid transfer plate from said second arm assembly and hold said liquid transfer plate when said liquid transfer plate dispenses said materials onto said target plate.

3. The system of claim 2 wherein said nest is controllably movable in the XYZ directions with a third arm assembly.

4. The system of claim 1 further comprising a fourth arm assembly for carrying and positioning said target substrate relative to said liquid transfer plate.

5. The system of claim 4 wherein said fourth arm assembly is controllably movable in the XYZ directions.

6. The system of claim 5 wherein said second arm assembly is configured to position said target substrate over said liquid transfer plate.

7. The system of claim 1 wherein said second arm assembly can rotate angularly such that said liquid transfer plate may be rotated upside down.

8. The system of claim 1 wherein said channels have a varying diameter from the fill side to the dispense side.

9. The system of claim 8 wherein said channels have a decreasing diameter from the fill side to the dispense side.

10. The system of claim 1 further comprising a multiwell plate stacker for holding a plurality of source well plates.

11. The system of claim 1 further comprising a liquid transfer plate stacker for holding a plurality of liquid transfer plates.

12. The system of claim 1 wherein the non-contact liquid dispensing device is an acoustic emitter positioned underneath the source well plate.

13. The system of claim 4 wherein said fourth arm assembly further comprises a target tray for holding at least one target substrate.

14. The system of claim 13 further comprising a tray stacker for holding a plurality of trays.

15. The system of claim 1 further comprising a camera for viewing dispensing.

16. The system of claim 1 further comprising a computer and said computer controls movement of said first and second arm assemblies.

17. The system of claim 16 wherein said computer further determines a number of target substrates to be printed such that a difference in time between loading the liquid transfer plate with materials to be dispensed and ejecting materials from said liquid transfer plate onto each of said target substrates is less than 10 seconds.

18. The system of claim 1 wherein said target substrate is a multiwell plate.

19. The system of claims 1 wherein said target substrate is a flat slide.

20. A liquid transfer plate for transferring biological and chemical materials onto a target substrate comprising a thin planar body having a fill side, a dispense side and a plurality of channels extending from said fill side to said dispense side.

21. The liquid transfer plate of claim 20 wherein said liquid transfer plate is rigid and formed from a substance selected from the group consisting of glass, ceramic, silicon wafer, plastic, stainless steel, tungsten, beryllium, and molybdenum.

22. The liquid transfer plate of claim 20 wherein said channels have a varying diameter.

23. The liquid transfer plate of claim 22 wherein said diameter decreases from said fill side to said dispense side.

24. The liquid transfer plate of claim 20 wherein said body has a thickness in a range of 4 mm to 0.1 mm.

25. The liquid transfer plate of claim 20 wherein said channels have a circular cross section and have a diameter in a range from 2 mm to 0.1 mm.

26. The liquid transfer plate of claim 25 wherein said diameter is in a range from 1 mm to 0.1 mm.

27. The liquid transfer plate of claim 20 wherein said body has a constant cross section from the fill side to the dispense side.

28. The liquid transfer plate of claim 20 wherein said channels form a rectangular array.

29. The liquid transfer plate of claim 20 wherein said channels form a non-rectangular array.

30. The liquid transfer plate of claim 20 wherein said body has a shape selected from the group of square and rectangular.

31. The liquid transfer plate of claim 20 wherein said body has a shape selected from the group of circular and oval.

32. A non-contact method for composing a microarray onto at least one target substrate comprising:
loading a first liquid transfer plate with primary materials to be printed; and
dispensing at least a portion of said primary materials onto said at least one target substrate.

33. The method of claim 32 wherein said loading comprises transferring a first liquid from a first source well of a multiwell plate to a first channel of a plurality of channels extending through said first liquid transfer plate.

34. The method of claim 33 wherein said loading further comprises transferring a second liquid from a second source well of said multiwell plate to a second channel of said first liquid transfer plate.

35. The method of claim 32 further comprising moving at least one of said first liquid transfer plate and said at least one target substrate into a dispense position such that when said primary materials are ejected from said liquid transfer plate said primary materials contact said at least one target plate.

36. The method of claim 34 wherein said dispensing includes dispensing a portion of said first and second liquids from said first and second channels respectively onto each target substrate of a first set of target substrates.

37. The method of claim 36 wherein said first and second liquids are dispensed onto 10 to 50 target substrates.

38. The method of claim 32 further comprising loading a second liquid transfer plate with ancillary materials.

39. The method of claim 38 wherein said loading the second liquid transfer plate is performed while said dispensing the primary materials is performed.

40. The method of claim 39 further comprising dispensing said ancillary materials onto a second set of target substrates.

41. The method of claim 38 wherein said second liquid is different than said first liquid.

42. A method for composing a microarray onto a plurality of target chips comprising:
selecting a number of spots to be printed onto a target chip;
determining a channel configuration for a liquid transfer plate used to dispense materials onto said plurality of target chips;
determining a number of liquid transfer plates necessary to complete printing said number of spots from said selecting step; and
determining a number of target chips such that the difference between the time to load materials into each and every channel of a liquid transfer plate and the time to print materials from a liquid transfer plate onto each and every target chip of said number of target chips (dT) is minimized.

43. The method of claim 35 wherein said dT is less than 100 seconds.

44. The method of claim 36 wherein said dT is less than 10 seconds.

45. The method of claim 37 wherein said dT is less than 1 second.
